(19) United States
(12) Patent Application Publication
(10) Pub. No.: US 2018/0192662 A1
(43) Pub. Date: Jul. 12, 2018

(54) METHOD FOR PRODUCING DAIRY PRODUCTS WITH THE ADDITION OF FRUIT, PLANT AND VEGETABLE EXTRACTS

(71) Applicant: Theodoros KOURELLAS, Grevena (GR)

(72) Inventor: Theodoros KOURELLAS, Grevena (GR)

(21) Appl. No.: 15/741,322

(22) PCT Filed: Dec. 4, 2015
(86) PCT No.: PCT/GR2015/000063

§ 371 Date: Jan. 2, 2018

(30) Foreign Application Priority Data
Jul. 7, 2015 (GR) 20150100305

(51) Int. Cl. A23C 9/133; A23C 9/156; A23C 19/09

(52) U.S. Cl. CPC A23C 9/133; A23C 19/09; A23C 9/156

(57) ABSTRACT

The invention relates to a method for producing dairy products with the addition of plant, fruit and vegetable extracts. The method comprises the steps of pasteurization, addition of an extract of one or more fruits, plants and vegetables in the case of milk preparation. When yogurt is prepared, the method comprises addition of a culture, fermentation and straining, whereas when cheese is produced, the method comprises coagulation, placing in containers with brine and curing for a suitable time period. In an alternative embodiment, herbs, fruits and vegetables may be added at the final step for enhancing the features of the final product.

### FIELD OF THE INVENTION

The invention relates to the field of methods for producing dairy products and in particular for producing dairy products with the addition of plant, fruit and vegetable extracts.

### BACKGROUND OF THE INVENTION

The method for producing dairy products with the addition of plant, fruit and vegetable extracts, has not been disclosed in the prior art.

A characteristic of our era is that the rhythms of life, as well as the associated demands, frequently lead humans to limiting conditions, forcing them to consume food supplements and vitamin formulations of ambiguous quality, in an effort to enhance the natural defense of the organism. Various factors influence the nutrition and thus health, the major ones being work stress, quality of food consumed, limited available time, environmental as well as financial conditions in a society. As a result, a complex and particularly difficult condition arises which each person attempts to solve in the individually optimal way. Thus, there are people who consume meals of ambiguous quality, aiming at satisfying the feeling of hunger, as well as people who like to prepare healthy meals, aiming at a more balance nutrition, and people who try to substitute the advantages and nutritional elements of a full meal with plant and chemical formulations which according to them provide the necessary nutritional elements.

It has been scientifically proved that bad nutrition causes numerous problems to man which range from apparent weight increase, reduction in fat metabolism, and increased heart function to sleeping problems, reduced brain function and sudden mood changes. Additionally, food supplements cannot be substitute for a balance nutrition, while the uptake of nutritional ingredients from the organism may be effected through the food and not through formulations rich in a nutritional ingredient.

In the case of dairy products, it is known that they constitute the main sources of calcium, with 3-4 cups of milk or yogurt daily supplying the organism with the recommended daily quantity. Also, it is known that there are no substitutes that can provide the same advantages features. Also, another point regards calcium intake, especially by women, for the prevention of osteoporosis.

It is an object of the present invention to address advantageously the above-mentioned disadvantages and deficiencies of the prior art, by proposing a method for producing dairy products where plant, fruit and vegetable extracts are added in order to achieve increased cytoprotective action of the produced products.

A further object of the present invention is to provide a method for producing dairy products which due to the addition of plant, fruit and vegetable extracts acquire nutritional ingredients, increasing the benefits to the consumer's health.

A further object of the present invention is to provide a method for producing dairy products with the addition of fruit, plant and vegetable extracts, which with their enriched nutritional ingredients increase the defense of the organism's defense.

A further object of the present invention is to provide a method for producing dairy products with the addition of fruit, plant and vegetable extracts, which provide protection to human cells when these are exposed to oxidative-stress conditions.

A further object of the present invention is to provide a method for producing dairy products with the addition of fruit, plant and vegetable extracts, which with small modifications may be used for the production of fresh milk, chocolate milk, milk beverages, fermented milk products, yogurt, yogurt with fruits, as well as cheese of various types (white, yellow, hard, semi-hard), or whey.

These and further objects, features and advantages of the invention will be fully apparent by the following detailed description.

### DETAILED DESCRIPTION OF A PREFERRED EMBODIMENT

Referring now to the accompanying figures we will describe exemplary embodiments of the method for preparing dairy products with the addition of fruit, plant and vegetable extracts.

The present description aims at presenting a method for preparing dairy products with the addition of fruit, plant and vegetable extracts, thereby reinforcing and improving their organoleptic and cytoprotective properties. According to the method presented in detail hereinbelow, extracts of fruit, plants and vegetables may be added both to fresh, pasteurized milk, and to any kind of cheese and yogurt, as well as to any kind of milk beverages and fermented milk products. As it will be apparent from the detailed description of the method, this addition may be effected both to the final product before its packaging, and to the starting material, without substantial variations in the final product.

The addition of fruit, plant and vegetable extracts may be effected in the milk starting material, after pasteurization and before its fermentation. The first step of the method is milk pasteurization at 72° C. for 15 seconds, i.e. the procedure during which mild heating is effected for the destruction or reduction of the germinated forms of the microorganisms. Pasteurization also aims at extending the lifetime of the product, reducing the number of pathogenic microorganisms that cause spoilage thereto. Thereafter, the extracts are added at a proportion of ca. 1% in relation to the total milk quantity, in case of milk—fresh milk or chocolate milk—and the product is packaged, whereas if the product is yogurt, milk beverage or fermented milk product, a culture is added at a proportion of one sachet per 1000 liters of mixture. After culturing, the mixture is left to ferment for four hours, then is strained and packaged. If the prepared product is cheese, and independently from the kind of cheese obtained, the mixture after the addition of culture is left to coagulate and ferment for two hours, before it is strained. Thereafter, it is placed in containers with brine, after 24 hours, where it cures for the necessary time period, before it is packaged. For example, extracts may be derived from fruits, such as apricot, avocado, or from vegetables, such as dill and tomato. Known plants that they can also be used include oregano, rosemary and thymus, without excluding the use of other fruits, vegetables or plants which have the necessary organoleptic and cytoprotective features that will enhance the nutritional properties of the dairy products.

In an exemplary embodiment of the invention, the addition of fruit, plant and vegetable extracts may be effected not to the starting material but to the final product. The product obtained will be similar, without notable differences for the consumer. Thus, during cheese preparation, after milk pasteurization for 15 seconds at 72° C., the culture is added at a proportion of one sachet per 1000 liters of milk. The product then coagulates and ferments for 2 hours before it is strained. To the mixture obtained the desired extract in brine is added at a proportion of 1% in respect to its total quantity, and after the end of the day it is placed in containers with brine. The method is completed with cheese curing for the necessary time period.

Respectively if the preparation relates to yogurt, yogurt with fruits, beverages or fermented milk products, after pasteurization at 72° C. for 15 seconds, the culture is added at a proportion of 1 sachet per 1000 liters. The product is fermented for four hours and strained. The extract is added at a proportion of 1% and the procedure is completed with packaging of the product.

In a further alternative embodiment of the method, instead of adding individual extracts of various plants, fruit or vegetables, a specific composition thereof may be added so that better results are obtained in respect to the protection of the cells of the human organism. It is apparent that addition of a composition, instead of individual extracts, does not differentiate the method in respect of the other steps of the preparation of the respective dairy products.

In a further alternative embodiment of the method, fresh fruits and vegetables may be used in the final step, so that the organoleptic and cytoprotective features of the final products are enhanced.

It should be noted that the description of the invention was made with reference to exemplary non-limiting embodiments. Thus, any variation or modification regarding the materials employed, steps of the methods, preparation procedure and respective time period of each step, as long as not constituting a new inventive step and not contributing to the progress of the state of the art, are considered encompassed in the scope of the present invention.

1. Method for producing dairy products with the addition of plant, fruit and vegetable extracts, characterized in that milk is pasteurized, an extract of a fruit, plant, or vegetable is added thereto and packaged.

2. Method for producing dairy products with the addition of plant, fruit and vegetable extracts, according to claim 1, characterized in that for the production of yogurt, a culture is added, the mixture is fermented, strained and then packaged.

3. Method for producing dairy products with the addition of plant, fruit and vegetable extracts, according to claim 1, characterized in that for cheese preparation, a culture is added, the product coagulates and ferments, is placed in brine, left to cure for the necessary time period and packaged.

4. Method for producing dairy products with the addition of plant, fruit and vegetable extracts, characterized in that the addition of an extract may be effected in the step before packaging of the product.

5. Method for producing dairy products with the addition of plant, fruit and vegetable extracts, according to claim 1, characterized in that the extract may consist of a combination of a fruit, a plant and a vegetable.
